(19) United States
(12) Patent Application Publication
(10) Pub. No.: US 2013/0335238 A1
(43) Pub. Date: Dec. 19, 2013

(54) METHOD AND DEVICE FOR TRAFFIC CONTROL

(71) Applicant: Parallels IP Holdings GmbH, (US)

(72) Inventor: Igor Yurievich Matsur, Tula (RU)

(21) Appl. No.: 14/002,743

(22) PCT Filed: May 11, 2011
(86) PCT No.: PCT/RU2011/000318

§ 371 Date: Sep. 3, 2013

(30) Foreign Application Priority Data
Mar. 3, 2011 (RU) 2011108056

(51) Int. Cl. G08G 1/087

(52) U.S. Cl. CPC G08G 1/087
USPC 340/906

(57) ABSTRACT

A method of traffic control at road intersections includes use of traffic lights, as well as detection and identification of vehicles approaching an intersection. To detect and identify a vehicle crossing the pre-set boundaries, we suggest mounting vehicle detection nodes probing the surrounding area using radio-frequency signals. In their turn, vehicles should be equipped with nodes, or tags, allowing their identification. When a vehicle equipped with an identification tag enters the monitored area, the tag generates a response containing the codeword with identification data of the vehicle, which is received and decoded by detection nodes. The duration of the green light signal is determined according to the time the vehicles, that have crossed the remote boundary during the last signal switching sequence, spent to cross the proximate pre-set boundary, and should not be shorter than that period.

### CROSS-REFERENCE TO RELATED APPLICATIONS

This application is a US National Phase of PCT Application No. PCT/RU2011/000318, filed on May 11, 2011, which claims priority to RU 2011/108056, filed on Mar. 3, 2011, which are all incorporated by reference herein in their entirety.

### BACKGROUND OF THE INVENTION

1. Field of the Invention

The present invention relates to traffic control and, more particularly, to traffic control at road intersections using traffic lights.

2. Background of the Related Art

A conventional method of traffic control at road intersections includes (see RU 2379761):
use of traffic lights;
traffic lights' signal switching through a relay with a timer clock;
calculation of the length of the portion of the road occupied by vehicles, located within the boundaries.

The time span between switching the lights from green to red (allowing and red light signals respectively) is set based on the average distance between vehicles approaching the road intersection, the number of vehicles on a given portion of the road, and a delay before the next vehicle starts moving after the preceding one.

One of the problems of this method is its low reliability, because it depends on data about the number of vehicles approaching the traffic lights obtained from camera footage. Recognition of vehicles in footage is error-prone, even if it has been made by a high-resolution detector, because it is impossible to supply standard reference images of all vehicles taken from every possible angle. Even a system detecting vehicles by their integral parts, such as license plates, is not reliable enough, since, in traffic, especially near the traffic lights, vehicles are so packed that it is difficult to discern their license plates, even if a detector is positioned at some elevation. It is also difficult to analyze the image when weather conditions deteriorate, and visibility is low.

It is also impossible, using this method, to set up automatic adaptation of the system to changes in traffic in order to coordinate traffic flows in intersecting directions, because there is no means to register the fact that a vehicle has crossed the monitored intersection, and that decreases the effectiveness of the known method.

These disadvantages thus limit the application of this method.

A conventional device for traffic control at road intersections consists of (see RU 2379761):

a. traffic lights;

b. a monitoring detector;

c. a traffic lights' unit with monitoring detectors;

d. a signal link between monitoring detectors and the signal processor;

e. a recognition unit, which can determine the length of the portion of the road occupied by vehicles moving in a given direction and the number of these vehicles;

f. a computing unit;

g. an adjustment unit for:
the benchmark time span between switching the lights, when there are no vehicles approaching the intersection,
the average speed of vehicles approaching the intersection,
the delay before the next vehicle starts moving after the preceding one;

h. a time-setting unit to set the time span between switching the lights;

i. a timer clock;

j. a switching relay;

k. a scanner for monitoring detectors.

One of the problems of this device is its low reliability, because it depends on data about the number of vehicles approaching the traffic lights obtained from camera footage. Recognition of vehicles in footage is error-prone, even if it has been made by a high-resolution detector, because it is impossible to supply standard reference images of all vehicles taken from every possible angle. Even a system detecting vehicles by their integral parts, such as license plates, is not reliable enough, since in traffic, especially near the traffic lights, vehicles are so packed, that it is difficult to discern their license plates, even if the detector is positioned at some elevation. It is also difficult to analyze the image, when weather conditions deteriorate and visibility is low.

It is also impossible, using this device, to set up automatic adaptation of the system to changes in traffic in order to coordinate traffic flows in intersecting directions, because there is no means to register the fact that a vehicle has crossed the monitored intersection, and that decreases the effectiveness of the known device.

These disadvantages thus limit the application of this device.

### SUMMARY OF THE INVENTION

Accordingly, the objective of the invention is to improve reliability of detection and identification of vehicles approaching the traffic lights and to raise effectiveness of traffic control using traffic lights by enabling it to adapt automatically to changes in traffic.

To achieve the objective, a method of traffic control at road intersections includes use of traffic lights, as well as detection and identification of vehicles approaching an intersection. To detect and identify a vehicle crossing the pre-set boundaries, vehicle detection nodes probing the surrounding area using radio-frequency signals are mounted. Vehicles should be equipped with nodes, or tags, allowing their identification. When a vehicle equipped with an identification tag enters the monitored area, the tag generates a response containing the codeword with identification data of the vehicle, which is received and decoded by detection nodes. The duration of the green light signal is determined according to the time the vehicles, that have crossed the remote boundary during the last signal switching sequence, spent to cross the nearer boundary, and should not be shorter than that period.

In addition:
the identification data of the vehicles, that have crossed the remote boundary during the last signal switching sequence, are stored in memory to be checked by the detection node mounted at the nearer boundary. The moment, when the last vehicle's identification data matches the stored data, is considered to be the moment when all the vehicles registered at the remote boundary finish crossing the approach to the intersection;
the remote boundary with a detection node is set to be 50-300 m away from the road intersection, and the nearer one is set in close proximity to it;
the red light signal is switched on only after all the vehicles, that have crossed the remote boundary during the last signal switching sequence, cross the nearer boundary in the given direction;
the duration of the red light signal is determined according to the duration of the green light signal for the intersecting direction;
the duration of the green light signal is determined based on movement of vehicles in both opposing directions;
if during the red light signal there are no vehicles to be detected in any intersecting direction, the green light signal is not switched on. Instead, the red light signal is renewed. In case there are no vehicles after the prohibiting has been renewed a set number of times in a row, the green light signal is switched on for a pre-set duration;
if the time period vehicles spend to pass from the remote boundary to the nearer one is longer than the average period by a specified value, the red light signal is switched on, and the vehicles, that have not crossed the nearer boundary, are considered to be parked;
if traffic rate at the intersection falls under a pre-set threshold value, the “blinking yellow” mode is turned on, or the signals are switched at a pre-set rate;
a radio response is generated by the identification tag with at least one parameter of the response corresponding to the vehicle identification data;
passive or active RFID-tags are used for vehicle identification.

Accordingly, the objective of the invention is to improve reliability of detection and identification of vehicles approaching the traffic lights and to raise effectiveness of traffic control using traffic lights by enabling it to adapt automatically to changes in traffic.

To achieve the objective, a device for traffic control using traffic lights includes:
vehicle identification nodes, or tags;
detection nodes mounted at the boundaries of the approach to the road intersection, which interact with vehicle identification tags via a radio-frequency channel;
a computing node with a memory unit.

Detection nodes mounted at the boundaries of the approach are connected to the computing node, which is, in turn, connected to the traffic lights port.

Each detection node includes an antenna, a transmitter and a receiver with a decoding unit to decode identification data of a vehicle.

Each identification tag includes a receiver and a transmitter, which generate a response containing the codeword with identification data of the vehicle.

In addition:
the remote boundary with a detection node is set to be 50-300 m away from the road intersection, and the nearer one is set in close proximity to it;
detection nodes are mounted under the roadway;
the computing node is connected to the traffic light port via switch signal generator, which provides the necessary coordination of signal levels;
passive or active RFID-tags are used for vehicle identification;
identification tags are equipped with an antenna.

Additional features and advantages of the invention will be set forth in the description that follows. Yet further features and advantages will be apparent to a person skilled in the art based on the description set forth herein or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE ATTACHED FIGURES

The accompanying drawings, which are included to provide a further understanding of the invention and are incorporated in and constitute a part of this specification, illustrate embodiments of the invention and, together with the description, serve to explain the principles of the invention.

In the drawings:

FIG. 1 illustrates a portion of the road filled with vehicles approaching a road intersection.

FIG. 2 contains an example of a signal-controlled intersection and shows layout of detection nodes.

FIG. 3 is a diagram of detection nodes orientation.

FIG. 4 is a schematic diagram of a device for traffic control.

FIG. 5 is the operating algorithm for the computing device.

### DETAILED DESCRIPTION OF EMBODIMENTS OF THE INVENTION

Reference will now be made in detail to the embodiments of the present invention, examples of which are illustrated in the accompanying drawings.

A method of traffic control at road intersections includes use of traffic lights, as well as detection and identification of vehicles approaching an intersection. To detect and identify a vehicle crossing the pre-set boundaries, we suggest mounting vehicle detection nodes probing the surrounding area using radio-frequency signals. In their turn, vehicles should be equipped with nodes, or tags, allowing their identification. When a vehicle equipped with an identification tag enters the monitored area, the tag generates a response containing the codeword with identification data of the vehicle, which is received and decoded by detection nodes. The duration of the green light signal is determined according to the time the vehicles, that have crossed the remote boundary during the last signal switching sequence, spent to cross the nearer boundary, and should not be shorter than that period.

The identification data of the vehicles, that have crossed the remote boundary during the last signal switching sequence, are stored in memory to be checked by the detection node mounted at the nearer boundary. The moment when the last vehicle's identification data matches the stored data is considered to be the moment when all the vehicles, registered at the remote boundary, finish crossing the approach to the intersection.

The remote boundary with a detection node is set to be 50-300 m away from the road intersection, and the nearer one is set in close proximity to it.

The red light signal is switched on only after all the vehicles, that have crossed the remote boundary during the last signal switching sequence, cross the nearer boundary in the given direction.

The duration of the red light signal is determined according to the duration of the green light signal for the intersecting direction. The duration of the green light signal is determined based on movement of vehicles in both opposing directions.

If during the red light signal there are no vehicles detected in any intersecting direction, the green light signal is not switched on. Instead, the red light signal is renewed. In case there are no vehicles after the prohibiting has been renewed a set number of times in a row, the green light signal is switched on for a duration specified by a timer clock.

If the time period that vehicles spend passing from the remote boundary to the nearer one is longer than the average period by a specified value, the red light signal is switched on, and the vehicles, that have not crossed the nearer boundary, are considered to be parked.

If a traffic rate at the intersection falls under a pre-set threshold value, the “blinking yellow” mode is turned on, or the signals are switched at a pre-set rate.

A radio response is generated by the identification tag with at least one parameter of the response corresponding to the vehicle identification data, such as signal phase, if phase modulation is used, signal frequency, if frequency modulation is used, signal amplitude, if amplitude modulation is used, or any combination of the above.

Passive or active RFID-tags are used for vehicle identification.

The method is implemented as follows:

Vehicles are to be equipped with identification nodes, or tags, which function as both receivers and transmitters, so they can receive signals generated by detection nodes and generate responses. Moreover, in order to enable identification of the vehicle by a detection node, the transmitter on the vehicle should be able to include an identifying codeword into the response generated.

Detection nodes are to be placed on two boundaries of the portion of the road approaching the road intersection: the farther one is set to be 50-300 m away from the intersection, and the nearer one is set immediately before the intersection (e.g. at the stop line). Detection nodes can be mounted on posts, at farms, or under the roadway.

If the road has several lanes for each direction, then detection nodes should be placed on each lane.

An intersection (including the signal-controlled ones) always has at least two intersecting directions. In the remainder of this description, it is assumed that one direction is called “the direction of traffic”, or “dir. A”, and the other one is called “the intersecting direction”, or “dir. B”. Both of them can also have opposing directions and contain more than one lane. Different directions can also have different traffic rate and traffic density, which are calculated based on the number of vehicles moving in that direction in unit time.

First, vehicles approaching the intersection, cross the remote boundary, passing a detection node. The identification tag of a vehicle generates a response containing the codeword with identification data of the vehicle. When a vehicle crosses the nearer boundary and enters the intersection, it is detected and registered again by another detection node. This system thus allows registering all vehicles crossing the farther and the nearer boundary in a given direction, until all vehicles pass the intersection.

All vehicles queuing before the intersection between the nearer and the farther boundaries, when the red light signal (‘red light’) has been switched on, have their identification data stored in the memory unit.

After the green light signal (‘green light’) is switched on, and the queued vehicles start moving, they are detected and registered again upon crossing the nearer boundary. Their identification data is matched to the data stored in memory. The green light signal is shown until all those queued vehicles have crossed the nearer boundary.

When the queued vehicles start moving and pass the road intersection, new vehicles crossing the remote boundary are registered. These new vehicles won't be allowed to cross the nearer boundary while the present green light signal is shown. After the last one of the previously queued vehicles passes the intersection, the red light signal is switched on. New vehicles are then registered and queued to pass the intersection the next time the green light signal is shown.

Thus, the duration of the green light signal is set according to the number of the queued vehicles, and after the last one of them crosses the nearer boundary, the red light signal is switched on.

If the average time span during which the queued vehicles are to be registered as crossing the nearer boundary is at least 5 times longer than a pre-set time span, then the red light signal is switched on, and the vehicles that have not crossed the nearer boundary are considered to be parking.

The signal switching sequence starts, when the green light signal is switched on, and ends, when the red light signal is switched off. Therefore, its duration equals durations of the green light signal and the following red light signal combined. Durations of the signals are not fixed, and they are repeatedly re-calculated according to the number of queuing vehicles, their size (length) and speed, the distance between them, etc.

When a sequence starts, a new queue of vehicles is formed, containing the vehicles, which have not crossed the nearer boundary during the green light signal and have approached the traffic lights during the red light signal. Thus, the queuing vehicles are registered at the start of each sequence.

Simultaneous detection and identification provides for reliable and precise registration of vehicles approaching and passing the road intersection.

When the traffic lights on dir. A show the red light signal, there is the green light signal shown on the traffic lights on dir. B. This signal is shown until all the queued vehicles cross the nearer boundary in dir. B. Then it changes for the red light signal, and the traffic lights on dir. A show the allowing signal.

Thus, the red light signal is switched on after, all the vehicles, which had crossed the remote boundary during the previous signal switching sequence, have crossed the nearer boundary. The duration of the green light signal is calculated based on the time span the queued vehicles require to pass the road intersection. That algorithm holds true for both directions, i.e., in every case, duration of the green light signal is calculated in the same fashion, in order to let all the queued vehicles pass the intersection.

When there are opposing directions in either of the intersecting ones, the duration of the red light signal for direction A is determined, so that all the vehicles queued in direction B can pass the intersection in both opposing directions, and vice versa.

The present invention features automatic changes in durations of the signals following fluctuations in traffic rate and density in both intersecting directions, in order to let all the queued vehicles, which have approached the traffic light during the previous signal switching sequence, pass the road intersection. That is executed through detection and identification of vehicles, which have entered the given portion of the road crossing its remote boundary .

All the vehicles registered as queuing before the traffic lights should be allowed to pass the road intersection during the next allowing signal. Thus, the traffic control system is not affected by such factors as varying size of vehicles and distance between them, as well as changes in speed due to different reasons, overtaking, etc. Until all the queued vehicles pass the intersection, no matter at what speed, the traffic lights signal won't change.

This automatic adaptation feature helps to balance traffic rates for all the directions on a given road intersection, thus improving efficiency of traffic control.

There are situations leading to fluctuations in traffic rates for the intersecting directions, e.g., there could be no, or very few, vehicles in dir. A, far below the number of vehicles in dir. B (the difference in traffic rates is more than a threshold value). In order not to delay the vehicles moving in dir. B, the green light signal for dir. A is not switched on, when it normally has to be. Instead, the signal switching sequence is considered incomplete because of the absence of the allowing signal, and the system proceeds with registering approaching and queuing vehicles.

If the system has to block the green light signal in one direction for several times in a row (e.g. five), then it is switched on the next time, its duration being equal to the duration of the previous green light signal or a pre-set value (e.g., 60 sec.). This feature allows letting a small number of queued vehicles pass the road intersection and also eliminates any registration errors, when the system failed to detect and identify a vehicle, or a vehicle entered the portion of the road from a side road without crossing the remote boundary . It can also be applied to let pedestrians cross the road.

If traffic rates decrease considerably for all directions, and duration of signal switching sequences falls below a threshold value, then the traffic lights enter the timer clock-controlled or the “blinking yellow” mode.

If more vehicles appear in any direction, or the average time period vehicles spend to pass between the boundaries is more than a pre-set value, when either the timer clock-controlled or the “blinking yellow” mode is active, the system resumes its standard procedure.

### Example

Vehicles, equipped with identification tags, approach the traffic lights crossing the remote boundary , which is 150 m away from the road intersection. The nearer boundary is at the stop line right in front of the traffic lights. Thus, 15-25 vehicles, depending on their size, can be queued there.

On both boundaries, under the roadway, there are detection nodes emitting signals in the direction of the vehicle. The main lobe of the detection node is turned upwards; its width is about 100°. When a vehicle's identification tag gets into the detector's range, it generates a response containing necessary identification data. This response should also contain a unique codeword, so that no error is made when multiple responses from a number of vehicles are registered by side lobes of detector nodes. One and the same vehicle is registered only once, regardless of the number of responses received by a detector node.

When the red light signal is switched on for the given direction, the control system registers the vehicles queuing between the boundaries by detecting and identifying them upon crossing the remote boundary and storing their identification data. These vehicles cannot cross the nearer boundary because the red light signal is on.

When the green light signal is switched on, the system starts registering, which of the queued vehicles have crossed the nearer boundary, by checking stored identification data of vehicles, that have approached the road intersection during the latest signal switching sequence, against identification data of vehicles crossing the nearer boundary. If there is a match, the vehicle is considered to have passed the intersection. Duration of the green light signal is calculated, so that to let all the queued vehicles cross the nearer boundary before the red light signal is switched on.

Both intersecting directions have their specified portions of the road approaching the traffic lights with farther and nearer boundaries to detect and identify vehicles, so that duration of the green light signal for both directions is calculated in the same way.

If there are no vehicles queuing in one of the directions, the green light signal is not switched on, and the red light signal is shown for the duration of the green light signal for the intersecting direction. In case the green light signal is blocked several times in a row, it is then turned on with a pre-set duration, in order to eliminate any registration errors, when the system failed to detect and/or identify a vehicle, or to let pedestrians cross the road.

If there are no, or very few, vehicles moving in both intersecting directions, and duration of signal switching sequences is too short, then the “blinking yellow” mode is turned on. When traffic rates increases, surpassing a threshold value, the system resumes its standard procedure.

Probing the area with vehicle detectors provides for complete and reliable identification of all vehicles crossing the boundaries of a given portion of the road, regardless of time of the day, seasons, weather and lighting conditions, thus increasing reliability of the system.

The system thus balances traffic rates for all the directions. Duration of traffic lights signals is automatically adapted to traffic rate fluctuations, which are registered through detection and identification of vehicles approaching the traffic lights, and the red light signal is turned on only after all the queued vehicles have passed the intersection.

This automatic adaptation feature helps to balance traffic rates for all the directions on a given road intersection, thus improving efficiency of traffic control.

The present method of dual radio-frequency detection and identification provides for reliable identification of vehicles, regardless of weather conditions, visibility and traffic rate.

All embodiments of the present invention can be implemented on the basis of existing standard components and radio elements, metallic constructions and fixtures, standard microchips, microwave emitters, etc.

Therefore, the present invention has much broader application compared to the conventional ones, since it increases reliability of detection and identification of vehicles approaching the traffic lights and improves efficiency of traffic control system by enabling it to adapt automatically to changes in traffic.

In the exemplary embodiment, the device for traffic control using traffic lights comprises:
traffic lights;
a vehicle's identification node, or tag, with an antenna;
detection nodes placed under the roadway at the boundaries of the approach to the road intersection.

Detection nodes mounted at the boundaries of the approach are connected to the computing node including a memory unit and a comparing node, which is, in turn, connected to the traffic lights port.

Each detection node consists of a transmitter and a receiver with an antenna.

Each identification tag consists of a receiver and a transmitter with an antenna.

The remote boundary with a detection node is set to be 50-300 m away from the road intersection, and the nearer one is set in close proximity to it;

Passive or active RFID-tags are used for vehicle identification.

The present device for traffic control functions as follows:

On both boundaries, under the roadway, there are detection nodes emitting signals in the direction of the vehicle, their main lobes are turned upwards.

When a vehicle's identification tag gets into the detector's range, it receives the signal and generates a response containing a unique codeword with necessary identification data, such as license plate number, vehicle body number, etc. This response is then received and decoded by the detection node.

A vehicle approaching the road intersection passes over detection nodes placed on the farther and the nearer boundaries. A vehicle is thus registered twice. Traffic on the intersection is controlled by traffic lights.

As the nearer boundary coincides with the stop line right before the traffic lights, the system can register both queuing vehicles and those, which have passed the intersection.

When a vehicle crosses the remote boundary , it is probed by the detection node, and its identification tag generates a response containing identification data of the vehicle. The identified vehicles approaching the road intersection are then stored in the memory unit.

During the red light signal for one direction, the system registers the queuing vehicles. Meanwhile, there is the green light signal for the intersecting direction.

All vehicles, which have crossed the remote boundary during the previous signal switching sequence and are queuing at the nearer boundary, are stored in the memory unit, until the next green light signal is switched on.

The duration of the green light signal is the time span required for all the queued vehicles, which are stored in memory, to pass the road intersection. They are registered by detection nodes upon crossing the nearer boundary. The entire matching procedure is carried out in real time, so that only those vehicles, which have been queuing before the traffic lights since the previous signal switching sequence, can pass the intersection.

The signal switching sequence is an green light signal followed by a prohibiting one. When the red light signal changes for the allowing one, and a new signal switching sequence begins, the memory unit is updated with identification data of vehicles, which have approached the road intersection during the previous signal switching sequence.

If there are no vehicles, which have crossed the remote boundary , the memory unit is not updated. In that case, the green light signal is blocked, and a new prohibiting period begins.

In case the green light signal for a given direction has been blocked for several times (e.g. five), the green light signal is switched on with a pre-set duration (e.g., 60 sec.). This feature helps to eliminate errors in detection and identification of vehicles, and to let pedestrians cross the road. Still, the detection nodes on the remote boundary remain active and feed the memory unit with new data. If traffic rate for a given direction increases above a threshold value, the system resumes its standard procedure.

Detection nodes should be placed on the boundaries at both intersecting directions and their opposites. The algorithm of the computing node is the same for all the directions, so that the green light signal for dir. A has the same duration as the red light signal for dir. B. Moreover, that duration is determined based on the number of queued vehicles in both opposing directions, thus allowing all of them pass the road intersection.

The present method of radio-frequency detection provides for full identification of vehicles approaching the road intersection, regardless of weather conditions, visibility and traffic rate. It also increases reliability of the device.

The present device provides for even traffic control in either direction and helps to balance traffic rates for intersecting directions in case they differ from each other. The system is able to adapt automatically to changing traffic rates, because it registers vehicles queuing before the road intersection and determines the duration of the green light signal based on their number, thus letting all of them pass the intersection. This feature helps to balance traffic in all directions.

The traffic lights switcher, which controls level and form of the output signal, can be designed as a power amplifier using key elements.

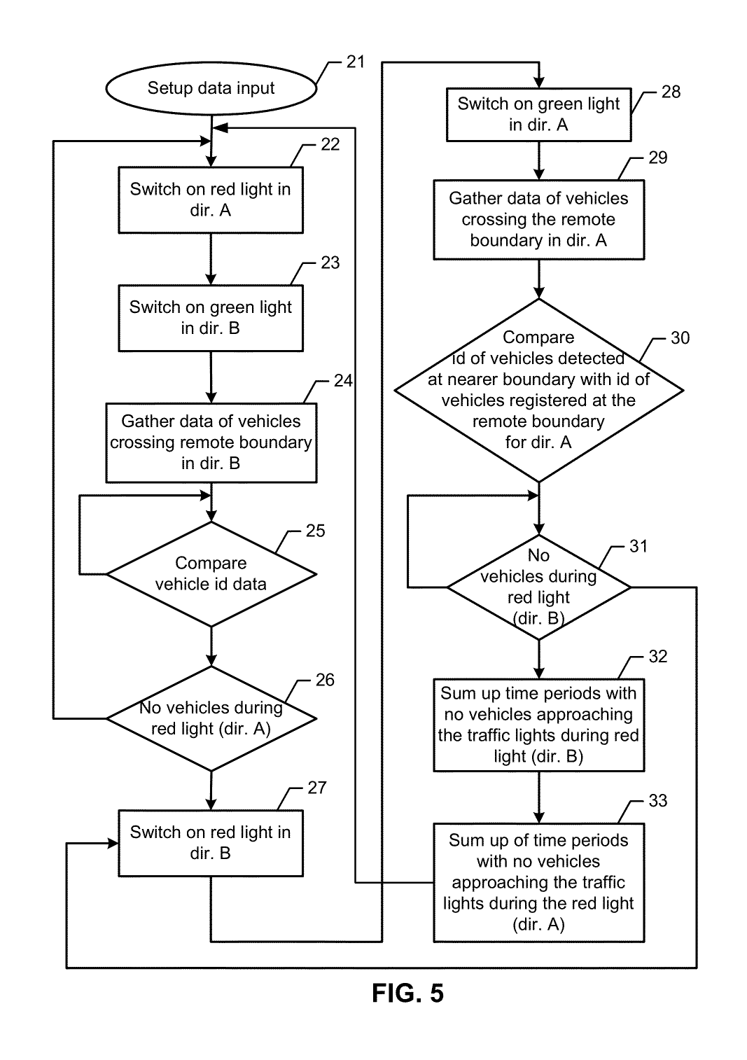

The computing node, which carries out the algorithm illustrated on FIG. 5, may be based either upon a CPU or upon digital logic. The algorithm needs some necessary values to be set first, such as fixed duration of the allowing signal, number of cycles without vehicles, after which the green light signal is switched on, etc.

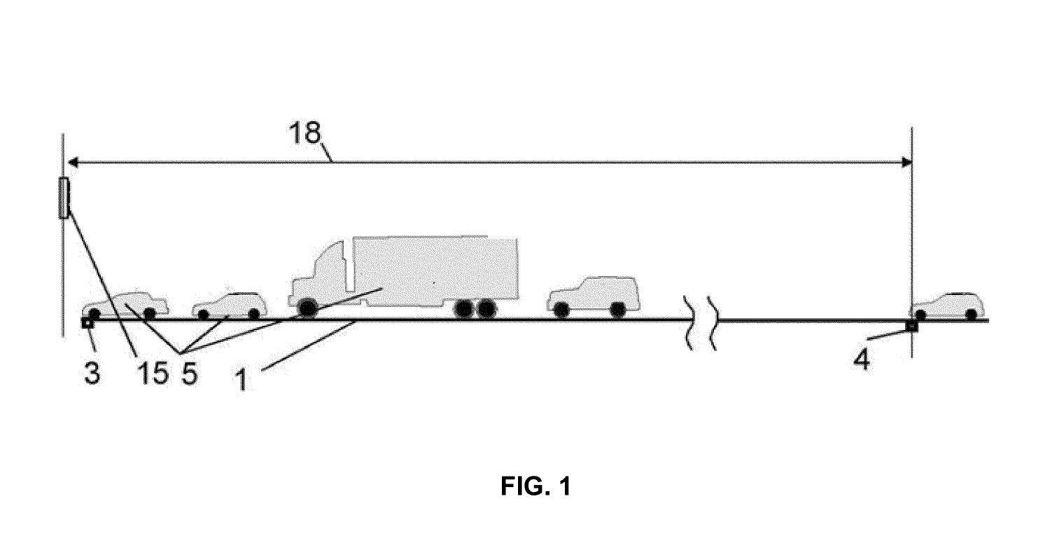

FIG. 1 illustrates a portion of the road filled with vehicles approaching a road intersection.

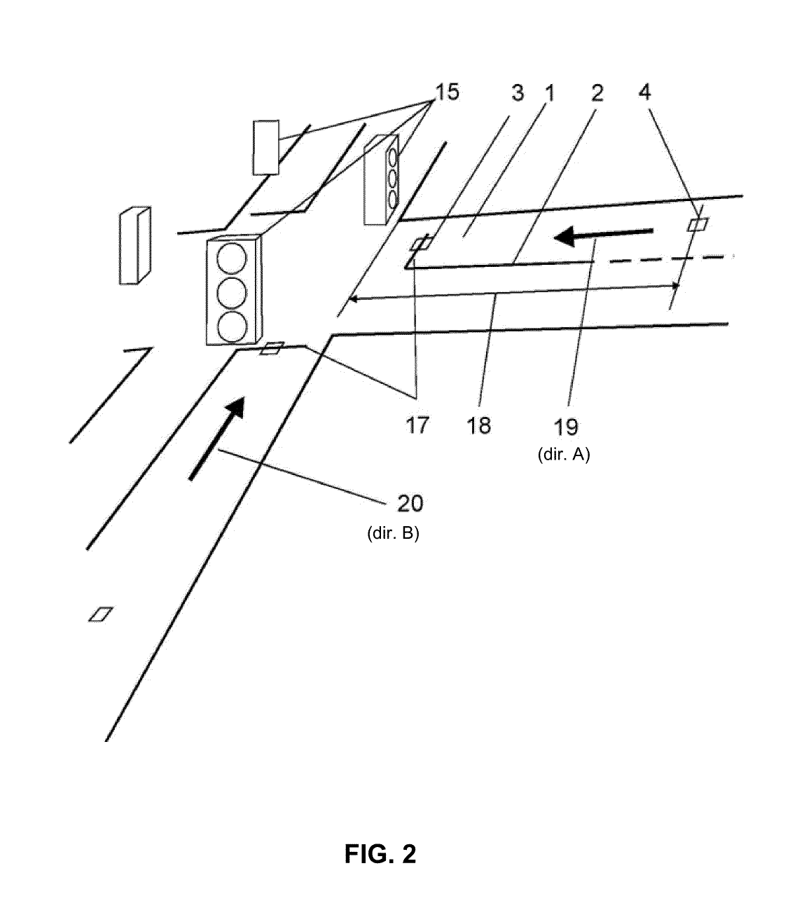

FIG. 2 contains an example of a signal-controlled intersection and shows layout of detection nodes.

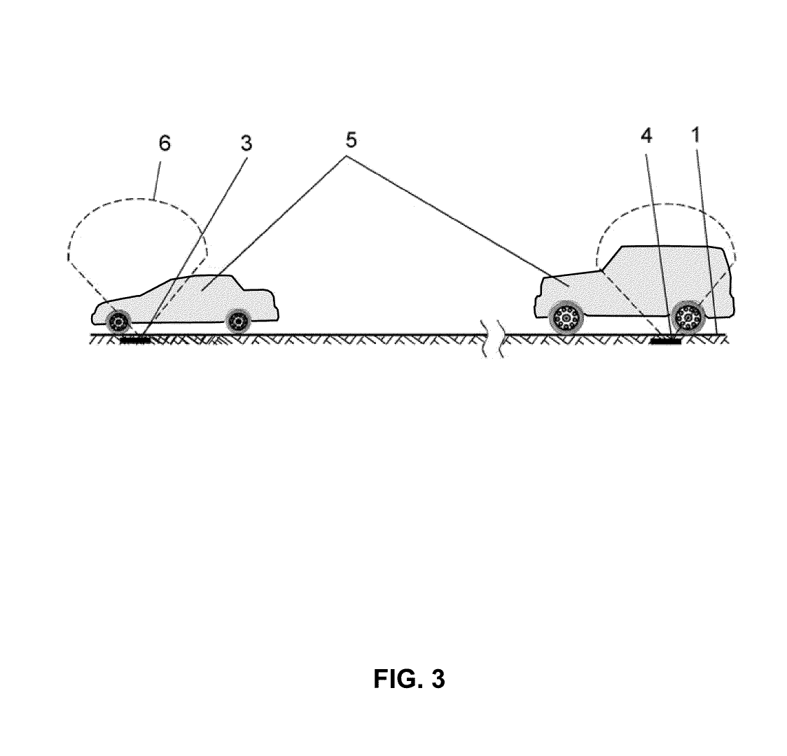

FIG. 3 is a diagram of detection nodes orientation.

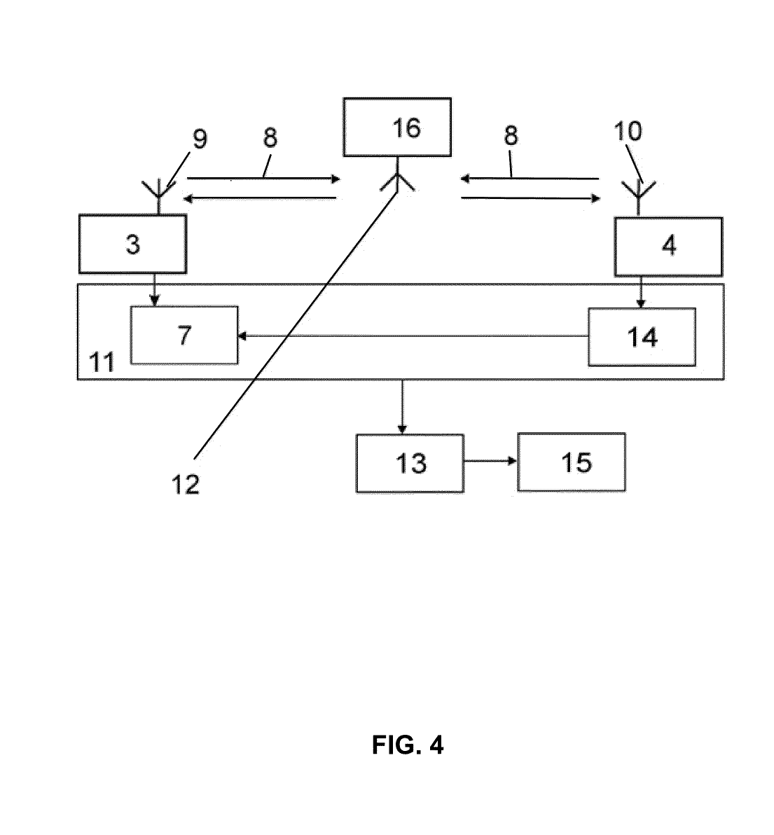

FIG. 4 is a schematic diagram of a device for traffic control.

FIG. 5 is the operating algorithm for the computing device.

There are following marks in the drawings:

1—a portion of the road approaching traffic lights;

2—road markings;

3, 4—detection nodes located on the nearer and the farther boundaries, respectively;

5—vehicles;

6—a diagram of an antenna orientation of a detection node;

7—a comparing node;

8—a radio-frequency channel;

9, 10—antennas of detection nodes located on the nearer and the farther boundaries, respectively;

11—a computing node;

12—an antenna of an identification tag;

13—a lights switching signal generator;

14—a memory unit;

15—traffic lights;

16—a vehicle identification node, or tag;

17—a stop line before the traffic lights;

18—distance between the road intersection with traffic lights to the remote boundary ;

19—traffic direction (dir. A);

20—intersecting traffic direction (dir. B);

21—setup data input (a benchmark number of periods with no traffic, a pre-set duration of the allowing signal, etc.)

22—switching on of the red light signal in dir. A;

23—switching on of the green light signal in dir. B;

24—gathering of data of vehicles crossing the remote boundary in dir. B for the next signal switching sequence;

25—comparing of identification data of vehicles detected at the nearer boundary with data of vehicles registered at the remote boundary, which is stored in the memory unit (dir. B);

26—a check of whether there have been no vehicles for a number of periods during the red light signal (dir. A);

27—switching on of the red light signal in dir. B;

28—switching on of the green light signal in dir. A;

29—gathering of data of vehicles crossing the remote boundary in dir. A for the next signal switching sequence;

30—comparing of identification data of vehicles detected at the nearer boundary with data of vehicles registered at the remote boundary, which is stored in the memory unit (dir. A);

31—a check of whether there have been no vehicles for a number of time periods during the red light signal (dir. B);

32—summing up of time periods, when there were no vehicles approaching the traffic lights during the red light signal (dir. A);

33—summing up of time periods, when there were no vehicles approaching the traffic lights during the red light signal (dir. B).

Transmitters and receivers of detection nodes and identification tags can be implemented on the basis of existing standard components and radio elements.

Therefore, the present device has much wider application if compared to the conventional ones, since it increases reliability of detection and identification of vehicles approaching the traffic lights and improves efficiency of traffic control system by enabling it to adapt automatically to changes in traffic.

Having thus described a preferred embodiment, it should be apparent to those skilled in the art that certain advantages of the described method and apparatus have been achieved. It should also be appreciated that various modifications, adaptations, and alternative embodiments thereof may be made within the scope and spirit of the present invention. The invention is further defined by the following claims.

What is claimed is:

1. A method of traffic control at road intersections, the method comprising:
detecting and identifying vehicles approaching an intersection at a remote boundary and a proximate boundary;
generating a radio-frequency (RF) signal and probing an area near the intersection with detection nodes mounted at the pre-set locations at the remote and proximate boundaries of an approach to the intersection;
receiving response signals from identification tags mounted on the vehicles that have entered the area, wherein each response signal includes a codeword with identification data corresponding to the vehicle;
detecting and decoding the response signals using the detection nodes; and
switching on and maintaining a green traffic light based on a time period that the vehicles, which have crossed the remote boundary in a given direction during the time period, when the traffic light was switched to red, and those vehicles, which have crossed the remote boundary in the same direction, but have not crossed the proximate boundary during the previous time period, when the traffic light was switched to green, cross the proximate boundary. The method of claim 1, further comprising storing in a memory the identification data of the vehicles that have crossed the remote boundary during a previous signal switching sequence, wherein the identification data is then checked by a detection node mounted at the proximate pre-set boundary, and
wherein a time when the vehicle's identification data matches the stored data is a time when all the vehicles registered at the remote boundary finish crossing the intersection.

3. The method of claim 1, wherein the remote boundary is about 50-300 m from the intersection, and the proximate pre-set boundary is no more than 10 meters from the intersection.

4. The method of claim 1, wherein the red light signal is switched on only after all the vehicles, which have crossed the remote boundary during the previous signal switching sequence, cross the proximate pre-set boundary in the same direction.

5. The method of claim 1, wherein the duration of the red light signal is based on a duration of the green light for the same intersecting direction.

6. The method of claim 1, wherein the duration of the green light signal is based on movement of vehicles in both opposing directions.

7. The method of claim 1, wherein, if during the red light signal there are no vehicles to be detected in any intersecting direction, the green light signal is not switched on, and the red light signal is renewed, and
when there are no vehicles after the red light signal has been renewed a predetermined number of times in a row, the green light signal is switched on for a pre-set duration.

8. The method of claim 1, wherein there is the average time period for vehicles to cross the portion of the road between the remote boundary and the proximate boundary, and if the time period for the detected vehicles is longer than the average time period by a pre-determined value, the red light signal is switched on, and those vehicles that have not crossed the proximate boundary are considered to be parked.

9. The method of claim 1, wherein, if traffic rate at the intersection falls under a pre-set threshold value, a “blinking yellow” mode is turned on, or the signals are switched at a pre-set rate.

10. The method of claim 1, wherein a radio response is generated by the identification tag with at least one parameter of the response corresponding to the vehicle identification data.

11. The method of claim 1, wherein passive or active RFID-tags are used for vehicle identification.

12. A system for traffic control using traffic lights, comprising:
a plurality of vehicle identification tags;
a plurality of detection nodes mounted at the boundaries of an approach to a road intersection, the detection nodes interacting with the vehicle identification tags via a radio-frequency channel;
a computing element with a memory unit coupled to the detection nodes and to the traffic lights of the road intersection;
each detection node including an antenna, a transmitter and a receiver with a decoding unit configured to decode identification data of a vehicle. each vehicle identification tag including a receiver and a transmitter, which generates a response containing the codeword with identification data of the vehicle.

13. The system of claim 12, wherein a remote boundary with a detection node is about 50-300 m from the road intersection, and a proximate pre-set boundary is no more than 10 m from the road intersection.

14. The device of claim 12, wherein detection nodes are mounted under the roadway.

15. The device of claim 12, wherein the computing node is connected to the traffic lights via a switch signal generator that coordinates signal levels.

16. The device of claim 12, wherein the vehicle identification tags are passive or active RFID-tags.

17. The device of claim 12, wherein each vehicle identification tag includes an antenna.
